(19) United States
(12) Patent Application Publication
(10) Pub. No.: US 2010/0120472 A1
(43) Pub. Date: May 13, 2010

(54) MOBILE TERMINAL AND KEY CODE SETTING METHOD OF MOBILE TERMINAL

(75) Inventors: Katsunori Takami, Tokyo (JP); Tosaku Tanada, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/535,901

(22) Filed: Aug. 5, 2009

(30) Foreign Application Priority Data
Nov. 7, 2008 (JP) P2008-286165

(51) Int. Cl. H04M 1/00; G08C 19/12

(52) U.S. Cl. 455/566; 341/173

(57) ABSTRACT

A mobile terminal provided with a predetermined input device includes a first set unit configured to set a key code of the input device designated by the active program, a first memory unit configured to store a predetermined key code of the input device, and an execution unit configured to executes a process based on the key code of the input device that is set by the first set unit when the event of the input device occurs, and executes the process based on the key code stored in the first memory unit when the key code of the input device is not set by the first set unit.

### BACKGROUND OF THE INVENTION

1. Field of the Invention

The present invention relates to a mobile terminal and a key code setting method of a mobile terminal which can be appropriately operated in response to the event of a newly added input device.

2. Description of the Related Art

Accompanied with sophistication of the mobile terminal such as a mobile phone, the input device provided for the mobile terminal has been diversified. Such input devices as a turn key for inputting data by turning a doughnut type (or circular) key, and an electrostatic pad for inputting data by sensing contact of the user's finger and a dedicated pen have been increasingly employed for the mobile terminal. Development of the technology for appropriately controlling operation events from various kinds of the input devices is demanded.

The mobile terminal device with a DJ play function has been proposed for subjecting the sound source data stored in the sound source memory to various types of special reproduction in response to the different operation applied to the mobile terminal device like the one performed by DJ (Japanese Unexamined Patent Application Publication No. 2006-80771). The mobile terminal device includes the sound source memory which stores sound source data, the DJ processor, the special reproduction processor for applying a specified reproduction process to the sound source data read from the sound source memory, the related table, and the unit for detecting the different operations of the mobile terminal device (for example, attitude/behavior detection unit). The related table sees the kind of special reproductions corresponding to different operations of the mobile terminal device, and the DJ processor refers to the related table to allow the special reproduction processor to reproduce according to the kind of special reproductions set in the related table based on the detection result of the means for detecting the different operations of the mobile terminal device.

There may be the case that the application program fails to define appropriate event of the input device for the mobile terminal, which is not specified by the interface in the platform of the application program (for example, turn key). When the event is newly added to the mobile terminal in the aforementioned case, the application program designed to be executed in the platform environment is unable to recognize the event. Such event, thus, may be ignored. In the aforementioned case, the application program cannot be controlled appropriately. Meanwhile, if the new event is replaced by the existing event of the platform of the mobile terminal, it will be difficult to establish the specific operation control of the now input device.

Accordingly, it is an object of the present invention to provide a mobile terminal and a key code setting method of a mobile terminal capable of performing appropriate operations in response to the event of the input device irrespective of the active application program.

The mobile terminal provided with a predetermined input device includes a first set unit configured to set a key code for the input device, which is designated by an active program, a first memory unit configured to store a predetermined key code of the input device, and an execution unit configured to executes a process based on the key code of the input device that is set by the first set unit when an event of the input device occurs, and executes a process based on the key code stored in the first memory unit when the key code of the input device is not set by the first set unit.

The key code setting method of the mobile terminal provided with a first setting step of setting a key code for the input device, which is designated by an active program; and a executing step of executing a process based on the key code of the input device that is set at the first setting step when an event of the input device occurs, and executes a process based on a predetermined key code when the key code of the input device is not set at the first setting step.

The mobile terminal and the key code setting method of the mobile terminal according to the present invention are capable of appropriately operating in response to the event of the input device irrespective of the active application program.

### BRIEF DESCRIPTION OF THE DRAWINGS

FIG. 1A is a front view showing a mobile terminal (mobile phone) according to the present invention in an opened state;

FIG. 1B is a side view of the mobile terminal (mobile phone) according to the present invention in the opened state;

FIG. 2A is a front view showing the mobile terminal (mobile phone) according to the present invention in a closed state;

FIG. 2B is a side view of the mobile terminal (mobile phone) according to the present invention in the closed state;

FIG. 3 is a function block diagram showing the mobile terminal (mobile phone) according to the present invention;

FIG. 4 shows a software module structure which allows an input control of a turn key of the mobile phone according to a first embodiment;

FIG. 5A is an explanatory view which schematically shows a method for executing the input control in response to a clockwise turning of the turn key of the mobile phone according to the first embodiment;

FIG. 5B is an explanatory view which schematically shows the method for executing the input control in response to a counterclockwise turning of the turn key of the mobile phone according to the first embodiment;

FIGS. 6A to 6D show transitional states of a menu screen on the display of the mobile phone according to the first embodiment resulting from turning operations of the turn key;

FIG. 7 schematically shows a process for switching the key code in accordance with the active application program while using the mobile phone according to the first embodiment;

FIGS. 8A to 8D show transitional states of a stand-by screen of the mobile phone according to the first embodiment resulting from turning operations of the turn key;

FIGS. 9A to 9D show transitional states of a navigation application screen of the mobile phone according to the first embodiment resulting from turning operations of the turn key;

FIG. 10 is a flowchart showing the routine of a turn key input control process in the mobile phone according to the first embodiment;

FIG. 11 is a flowchart showing the routine of the turn key input control process in the mobile phone according to the first embodiment;

FIG. 12 shows a software module structure which allows an input control of a turn key of the mobile phone according to a second embodiment; and

FIG. 13 is a flowchart showing the routine of the turn key input control process in the mobile phone according to the second embodiment.

### DESCRIPTION OF THE PREFERRED EMBODIMENTS

### First Embodiment

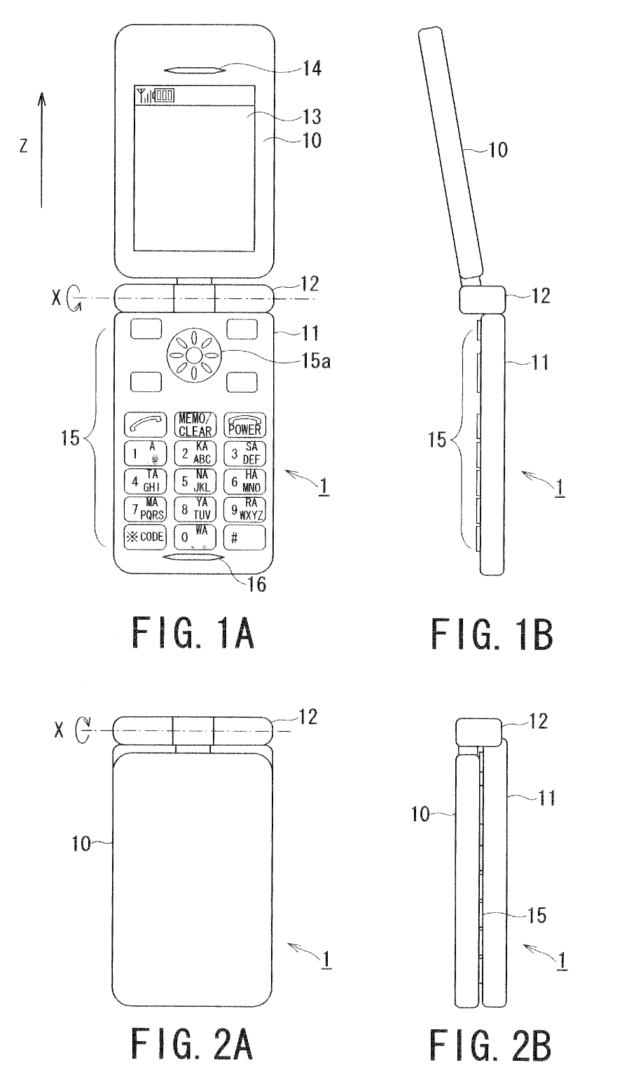

A mobile terminal and a key code setting method of a mobile terminal according to a first embodiment of the present invention will be described referring to FIGS. 1 to 11. The mobile terminal according to the first embodiment will be described as a clamshell type mobile phone 1 formed by connecting plural casings which can be freely opened and closed. FIG. 1A is a front view of the mobile phone 1 in an opened state, and FIG. 1B is a side view of the mobile phone 1 in the opened state. FIG. 2A is a front view of the mobile phone 1 in a closed state, and FIG. 2B is a side view of the mobile phone 1 in the closed state.

The mobile phone 1 is formed of a rectangular plate-like upper casing 10 and a lower casing 11 with substantially the same shape as the upper casing 10 as shown in FIGS. 1 and 2. Those upper casing 10 and the lower casing 11 have opposite surfaces overlapped with each other. They are hinged with a hinge portion 12 therebetween. The upper casing 10 is turnable at a predetermined angle in a direction X with respect to the lower casing 11 around the hinge portion 12 as an axis as shown in FIGS. 1 and 2. The mobile phone 1 allows the upper casing 10 to turn with respect to the lower casing 11 so as to change from the closed state to the opened state or vice versa.

The upper casing 10 has a display 13 for displaying such display information as characters and images on the inner surface (opposite the lower casing 11). The display 13 may be the liquid crystal display formed of the liquid crystal panel, the organic EL display formed of the organic EL panel and the like. The upper casing 10 has a speaker 14 for outputting sounds on the inner surface. The display 13 and the speaker 14 are covered with the lower casing 11 so as not to be exposed outside when the mobile phone 1 is in the closed state. It is exposed outside when the upper casing 10 is turned with respect to the lower casing 11 into the opened state. The screen of the display 13 is visible to the user by bringing the mobile phone 1 into the opened state.

The lower casing 11 includes plural operation keys 15 which are depressed to input commands on the inner surface (opposite the upper casing 10). The operation key 15 includes a power key for switching ON/OFF of the power source, a call key for calling, an end key for finishing the call, a ten-key for inputting numbers and characters, a clear key for deleting the input numbers and characters, a soft key set to an arbitrary function in accordance with the active application program, a short cut key for activating the mail function and Web browsing function, and the like.

The lower casing 11 includes a turn key 15a which is turned for inputting commands based on the turning direction and the turning angle on the inner surface. The turn key 15a may be formed into a ring shape like a doughnut, and allows the user to depress a predetermined position (for example, up, down, left and right) for inputting commands besides the turning operation. The mobile phone 1 allows the user not only to input corresponding to depression of the predetermined position (up, down, left and right) using the turn key 15a, but also to input by the turning operation. The user may perform quick input by appropriately allocating the general function to the input operation through turning (in case of no input through the turning operation, the general operation will be performed).

The lower casing 11 includes a microphone 16 for collecting sounds on the inner surface. When the mobile phone 1 is in the closed state, those operation keys 15, the turn key 15a and the microphone 16 are covered with the upper casing 10 and, accordingly, are not exposed outside. When the mobile phone 1 has its shape changed into the opened state by turning the upper casing 10 with respect to the lower casing 11, they are exposed outside. The user is allowed to input through the operation keys 15 and the turn key 15a by bringing the mobile phone 1 into the opened state.

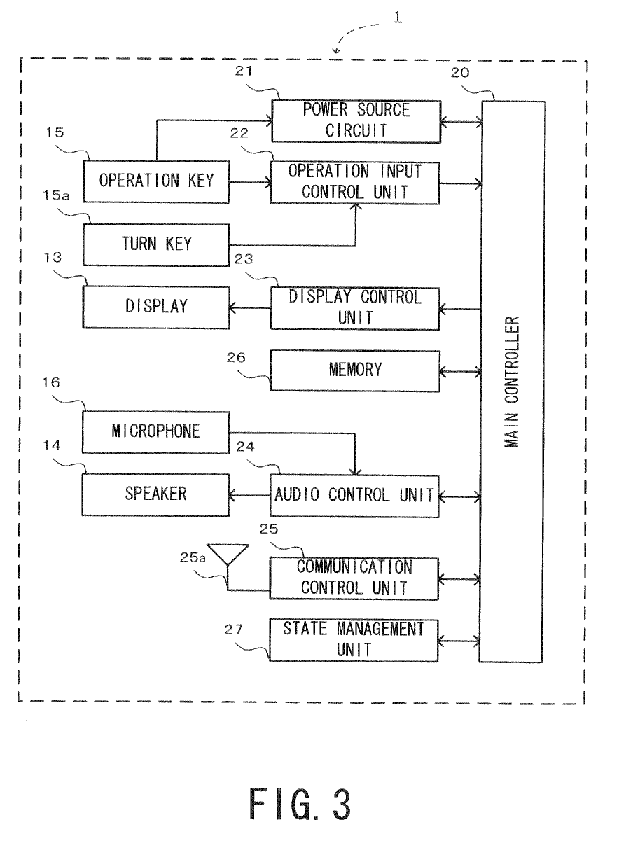

Functions of the mobile phone 1 will be described referring to the block diagram shown in FIG. 3. Referring to FIG. 3, the mobile phone 1 includes a main controller 20, a power circuit 21, an operation input control unit 22, a display control unit 23, an audio control unit 24, a communication control unit 25, a memory 26, and a state management unit 27 which are connected with one another via bus lines.

The main controller 20 is equipped with a CPU to centrally control the mobile phone 1 as well as executes various calculations and control operations. The power circuit 21 switches the power source ON and OFF based on the user's input through the operation keys 15. When the power source is ON, electric power is supplied from the power source (battery and the like) to the respective components to activate the mobile phone 1.

The operation input control unit 22 is equipped with an input interface for the operation key 15. Upon detection of depression of the operation key 15, the signal indicating the depressed key is generated so as to be transferred to the main controller 20. The operation input control unit 22 is further equipped with an input interface for the turn key 15a. Upon detection of depression of the turn key 15a, the signal indicating the depressed position is generated so as to be transferred to the main controller 20. Upon detection or turning of the turn key 15a, the signal indicating the turning direction and the turning angle is generated so as to be transferred to the main controller 20.

The display control unit 23 is equipped with a display interface for the display 13, and allows the screen of documents and images to be displayed on the display 13 under the control of the main controller 10. The display control unit 23 generates the information indicating whether the vertical display (display along the direction Z as the up-and-down direction as shown in FIG. 1) or the lateral display (display along the direction Z as the left-to-right direction as shown in FIG. 1) based on the command from the main controller 20 and the operation input control unit 22. The generated information is transmitted to the main controller 20 and the operation input control unit 22.

The audio control unit 24 generates an analog audio signal from the sound collected by the microphone 16 under the control of the main controller 20. The generated analog audio signal is converted into a digital audio signal. Upon reception of the digital audio signal, the audio control unit 24 converts the digital audio signal into the analog audio signal under the control of the main control unit 20 so as to be output from the speaker 14 as sounds.

The communication control unit 25 subjects the reception signal received from the base station (not shown) via an antenna 25a to the spread spectrum inverse processing under the control of the main controller 20 to restore data. The data may be transferred to the audio control unit 24 so as to be output from the speaker 14, transferred to the display control unit 23 so as to be displayed on the display 13, or stored on the memory 26 in response to the command from the main controller 20. Upon reception of the audio data collected by the microphone 16, the data input through the operation keys 15, and the data stored in the memory 26, the communication control unit 25 subjects those data to the spread spectrum processing under the control of the main controller 20 so as to be transmitted to the base station via the antenna 25a.

The memory 26 includes a ROM and a hard disk for storing the processing program and data for the processing to be executed by the main controller 20, the non-volatile memory, database, and a RAM which temporarily stores the data used for processing performed by the main controller 20 and the operation input control unit 22.

The state management unit 27 is equipped with an acceleration sensor for determining a holding state of the mobile phone 1 using the detection value of the acceleration sensor under the control of the main controller 20 and the operation input control unit 22. When the longitudinal direction of the casing corresponds to the vertical direction (direction Z shown in FIG. 1 as the vertical direction), the state management unit 27 determines that the mobile phone 1 is held in the vertical direction. Meanwhile, when the longitudinal direction of the casing corresponds to the horizontal direction (direction Z shown in FIG. 1 as the horizontal direction), it is determined that the mobile phone 1 is held in the lateral direction. The state management unit 27 generates the information indicating the state of the mobile phone 1 based on the command from the main controller 20 and the operation input unit 22 such that the information is transmitted to the main controller 20 and the operation input unit 22.

The mobile phone 1 has the function for appropriately informing the platform of the application program (hereinafter simply referred to as the platform) of the event from the input device. In the case where the event of the new input device is not designated by the platform because the active application program is not designed to use the input device, the application program is informed of the default key event.

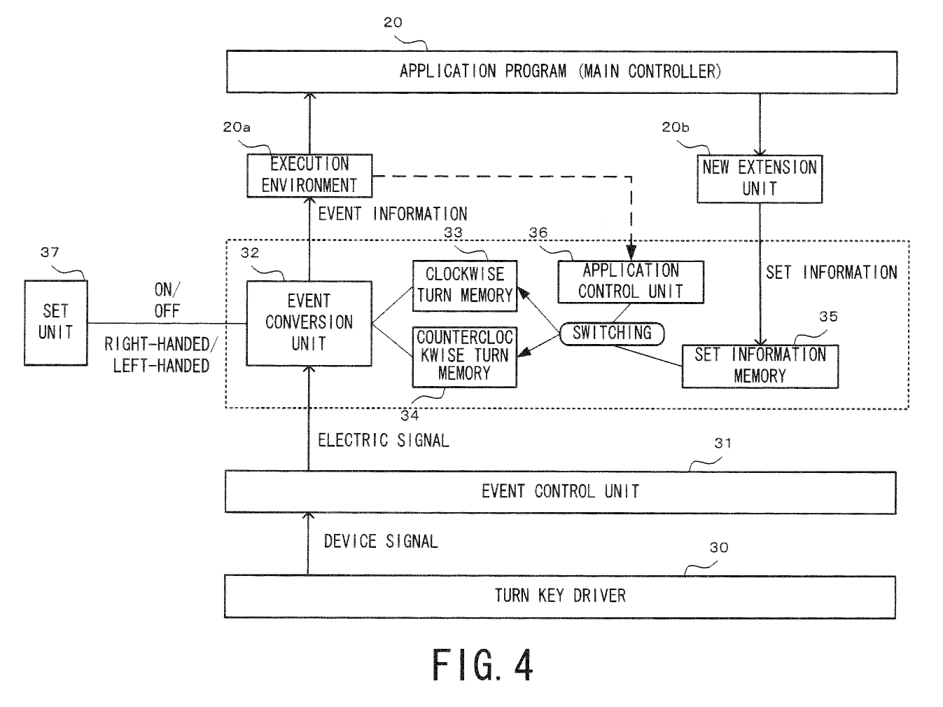

The operation upon input through the turn key 15a will be described hereinafter. FIG. 4 shows a software module structure which allows the operation input control unit 22 of the mobile phone 1 to realize the input control of the turn key 15a. The operation input control unit 22 induces a turn key driver 30, an event control unit 31, an event conversion unit 32, a clockwise turn memory 33, a counterclockwise turn memory 34, a set information memory 35, and an application control unit 36.

When the turn key 15a is turned and depressed, the turn key driver 30 generates a device signal indicating such event so as to be transmitted to the event control unit 31. If the turn key 15a is turned, the device signal is transmitted to the event control unit 31 for each detection of turning at the predetermined angle. The event control unit 31 generates the electric signal which can be recognized by the platform so as to be transmitted to the event conversion unit 32 based on the device signal received from the turn key driver 30.

Upon reception of the electric signal from the event control unit 31, the event conversion unit 32 converts the electric signal for generating the event information based on the active application program so as to be transmitted to the main controller 20 which is executing the application program. The clockwise turn memory 33 stores a clockwise turn key code of the turn key 15a, and the counterclockwise turn memory 34 stores the counterclockwise turn key code of the turn key 15a. Upon reception of the turning event of the turn key 15a, the event conversion unit 32 generates the event information based on the clockwise and counterclockwise turn key codes.

The clockwise turn memory 33 stores the downward event (having the direction Z shown in FIG. 1 as the upward direction) as the default value. The counterclockwise turn memory 34 stores the upward event as the default value. If the active application program has no set information with respect to the clockwise turn key code and the counterclockwise turn key code, those default values may be used.

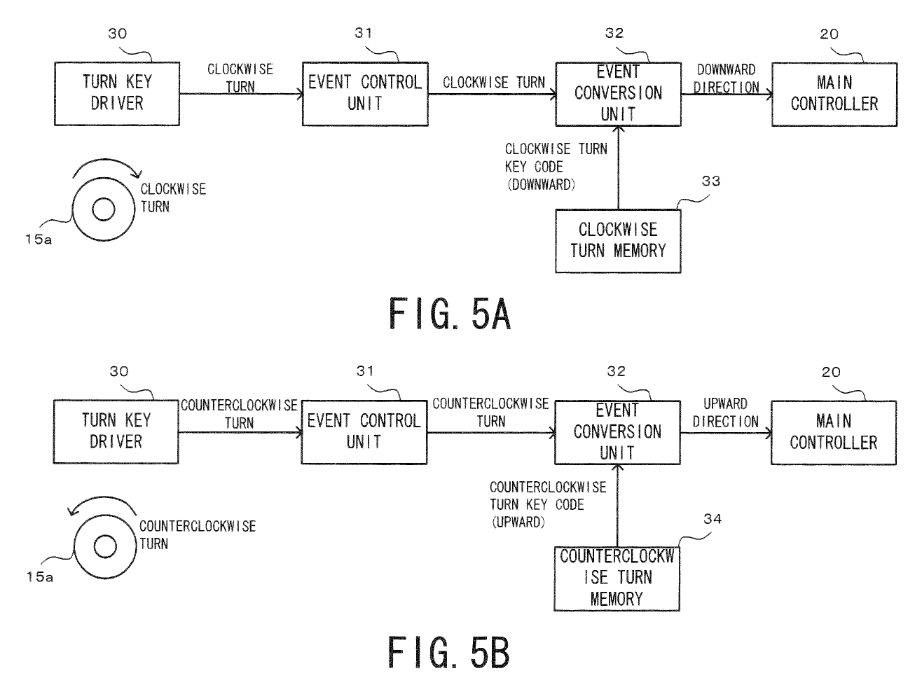

Referring to FIG. 5A, when the turn key 15a is turned clockwise at the predetermined angle, the turn key driver 30 transmits the device signal indicating the clockwise direction to the event control unit 31. The event control unit 31 then transmits the electric signal indicating the clockwise direction to the event conversion unit 32. If the key code indicating the downward direction is stored in the clockwise turn memory 33, the event conversion unit 32 transmits the event information indicating the downward direction to an execution environment 20a (main controller 20) of the application program based on the key code.

Referring to FIG. 5B, when the turn key 15a is turned counterclockwise at the predetermined angle, the turn key driver 30 transmits the device signal indicating the counterclockwise direction to the event control unit 31. The event control unit 31 then transmits the electric signal indicating the counterclockwise direction to the event conversion unit 32. If the key code indicating the upward direction is stored in the counterclockwise turn memory 34, the event conversion unit 32 transmits the event information indicating the upward direction to the execution environment 20a (main controller 20) of the application program based on the key code.

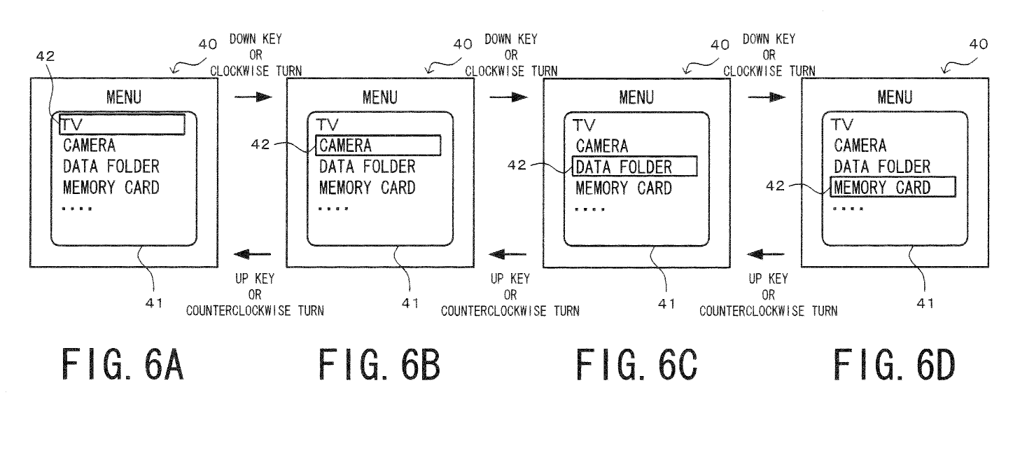

FIGS. 6A to 6D show transitional states of the screen resulting from operating the turn key 15a when a menu 41 is displayed on the screen 40 of the display 13. Referring to FIG. 6A, the menu 41 displays “TV”, “Camera”, “Data folder”, and “Memory card” sequentially from the top. In the state where a cursor 42 locates on the “TV”, when the downward portion (down key) of the turn key 15a is depressed or the turn key 15a is turned clockwise, the cursor moves to the “Camera” next to the “TV” as shown in FIG. 6B.

In the state where the cursor 42 locates on the “Camera” as shown in FIG. 6B, when the downward portion (down key) of the turn key 15a is depressed or the turn key 15a is turned clockwise, the cursor moves to the “Data folder” next to the “Camera” as shown in FIG. 6C. When the upward portion (up key) of the turn key 15a is depressed or the turn key 15a is turned counterclockwise, the cursor 42 moves to the “TV” previous to the “Camera”.

Referring to FIG. 6C, in the state where the cursor 42 locates on the “Data folder”, when the downward portion (down key) of the turn key 15a is depressed, or the turn key 15a is turned clockwise, the cursor 42 moves to the “Memory card” next, to the “Data folder” as shown in FIG. 6D. When the upward portion (up key) of the turn key 15a is depressed or the turn key 15a is turned counterclockwise, the cursor 42 moves to the “Camera” previous to the “Data folder” as shown in FIG. 6B.

In the state where the cursor 42 locates on the “Memory card” as shown in FIG. 6D, when the upward portion (upper key) of the turn key 15a is depressed, or the turn key 15a is turned counterclockwise, the cursor 42 moves to the “Data folder” previous to the “Memory card” as shown in FIG. 6C.

As the turning operation of the turn key 15a is correlated with the depressing operation of the turn key 15a and the operation key 15, the user who desires to move the cursor 42 on the screen 40 of the display 13 is allowed to move it not only by depressing the operation key 15 and the turn key 15a, but also by turning the turn key 15a.

If the turning event of the turn key 15a is converted into the arbitrary key code, the originally defined key code operation and the turning operation of the turn key 15a may be performed simultaneously, resulting in the conflict between the events. In order to solve the aforementioned problem, transmission of the turning event of the turn key 15a is inhibited while the key code corresponding to the turning event of the turn key 15a is operated.

The main controller 20 obtains the event information from the event conversion unit 32 in the execution environment 20a of the active application program, and performs the process for the application program based on the event information.

When the application program is activated by the main controller 20, a new extension unit 20b obtains a key code of the turn key 15a from the active application program so as to be stored in the set information memory 35 as the set information. If plural application programs are executed by the main controller 20, the plural set information data are stored in the set information memory 35.

In the case where the set information of the application program as stored in the set information memory 35 by the new extension unit 20b, when the application program is active (the most significant), the key code for the turn key 15a is set in the clockwise turn memory 33 and the counterclockwise turn memory 34 through synchronizing process. If it is not active, the key code is stored only in the set information memory 35. Upon transition of the application program to the active state, the key code for the turn key 15a may be set in the clockwise turn memory 33 and the counterclockwise turn memory 34.

The application control unit 36 controls the plural application programs executed by the main controller 20. That is, when the main controller 20 executes the plural application programs, only the most significant application program among those executed becomes active. Then the UI processing (key operation and the like) for the active application program may only be executed. Accordingly, when the active application program is switched to another one, the application control unit 36 changes the clockwise turn key code for the turn key 15a to be stored in the clockwise turn memory 33 and the counterclockwise turn key code for the turn key 15a to be stored in the counterclockwise turn memory 34 based on the newly activated application program and the set information stored in the set information memory 35.

Upon switching of the active application program, the event conversion unit 32 converts the turning operation of the turn key 15a based on the clockwise turn key code and the counterclockwise turn key code which have been changed by the application control unit 36. The event information to be informed to the execution environment 20a of the application program contains the clockwise turn key code and the counterclockwise turn key code which have been changed by the application control unit 36.

If the active application program does not designate the key code corresponding to the turning operation of the turn key 15a, default values preliminarily stored in the clockwise turn memory 33 and the counterclockwise turn memory 34 may be used.

The key codes set in the clockwise turn memory 33 and the counterclockwise turn memory 34 by the application control unit 36 are kept effective from start of the foreground to the end of the application program. The effective range of the key code is valid only when the set application program is active.

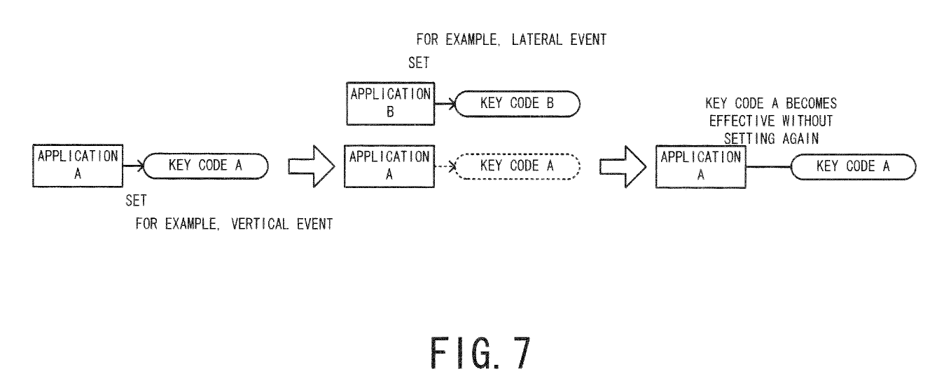

Referring to FIG. 7, if an application A as the application program is active, the key code A (for example, the event in the up-and-down direction) designated by the application A becomes effective. Thereafter, if an application B as the application program becomes active, the key code B (for example, the event in the left-to-right direction) designated by the application B becomes effective. If the application A becomes active again resulting from finishing the application B, the key code A designated by the application A becomes effective.

The key code designated by the application program is stored in the set information memory 35 until the end of the application program. When the application program is activated, the key code designated thereby becomes effective based on the information stored in the set information memory 35 irrespective of the command for setting the key code again from the application program.

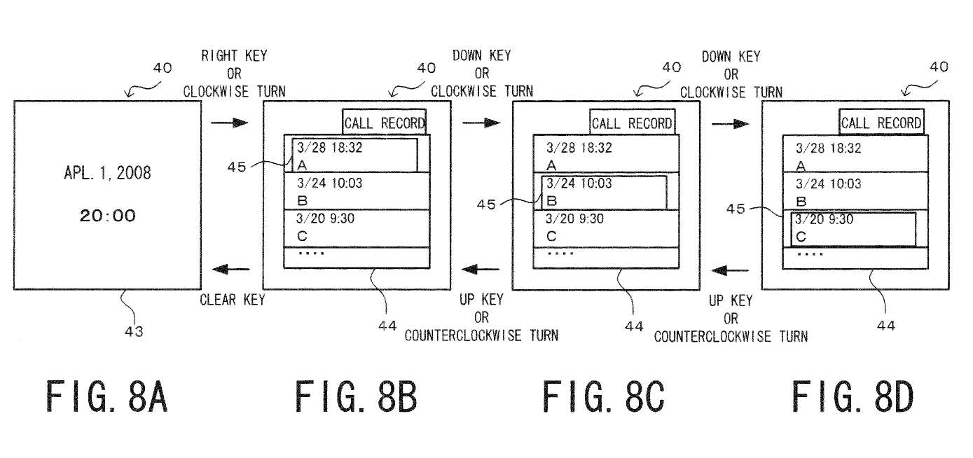

FIGS. 6A to 8D show transitional, states of the screen resulting from operating the turn key 15a when a stand-by screen 43 is displayed on the screen 40 of the display 13. Referring to FIG. 8A, while the stand-by screen 43 is displayed, a stand-by state key code which correlates the clockwise turn with the right portion (right key) of the turn key 15a is set in the clockwise turn memory 33 and the counterclockwise turn memory 34. In the case where the right portion (right key) of the turn key 15a is depressed or the turn key 15a is turned clockwise in the aforementioned state, a call record screen 44 is displayed on the screen 40 based on the stand-by state key code as shown in FIG. 8B.

On the call record screen 44, the records for calling “A”, “B”, and “C” are sequentially displayed. The cursor 45 locates on the “A” position. When the call record screen 44 is displayed on the screen 40, the key code indicating the call record display state is set in the clockwise turn memory 33 and the counterclockwise turn memory 34 having the clockwise turn correlated with the downward portion (down key) of the turn key 15a, and the counterclockwise turn correlated with the upward portion (up key) of the turn key 15a, respectively.

Referring to FIG. 8B, in the case where the cursor 45 locates on the position “A”, when depressing downward portion (down key) of the turn key 15a, or the turn key 15a is turned clockwise, the cursor 45 moves to the position “B” next to “A” as shown in FIG. 8C based on the key code indicating the call record display state. When the clear key is depressed, the display is changed from the call record screen 44 to the stand-by screen 43 again as shown in FIG. 8A. In the aforementioned state, the stand-by key code is set again in the clockwise turn memory 33 and the counterclockwise turn memory 34.

Referring to FIG. 8C, in the case where the cursor 45 locates on the position “B”, when the downward portion (down key) of the turn key 15a is depressed, or the turn key 15a is turned clockwise, the cursor 45 moves to the position “C” next to “B” as shown in FIG. 8D based on the key code indicating the call record display state. When the upward portion (up key) of the turn key 15a is depressed, or the turn key 15a is turned counterclockwise, the cursor 45 moves to the position “C” previous to “B” as shown in FIG. 8B based on the key code indicating the call record display state.

Referring to FIG. 8D, in the case where the cursor 45 locates on the position “C”, when the upward portion (up key) of the turn key 15a is depressed, or the turn key 15a is turned counterclockwise, the cursor 45 moves to “B” previous to “C” based on the key code indicating the call record display state as shown in FIG. 8C.

The key code is switched based on the currently executed most significant application program. If the application program executed with the most significance in the mobile phone 1 is switched, the user is allowed to continue the operation using the turn key 15a without feeling discomfort.

The key code may be set for each application program. Besides, the key code may be set for various states in the respective applications so as to be switched depending on the change in the state. For example, the certain application may be designed to perform the first operation based on the key code A upon start of the application, and perform the subsequent operations based on the key code B.

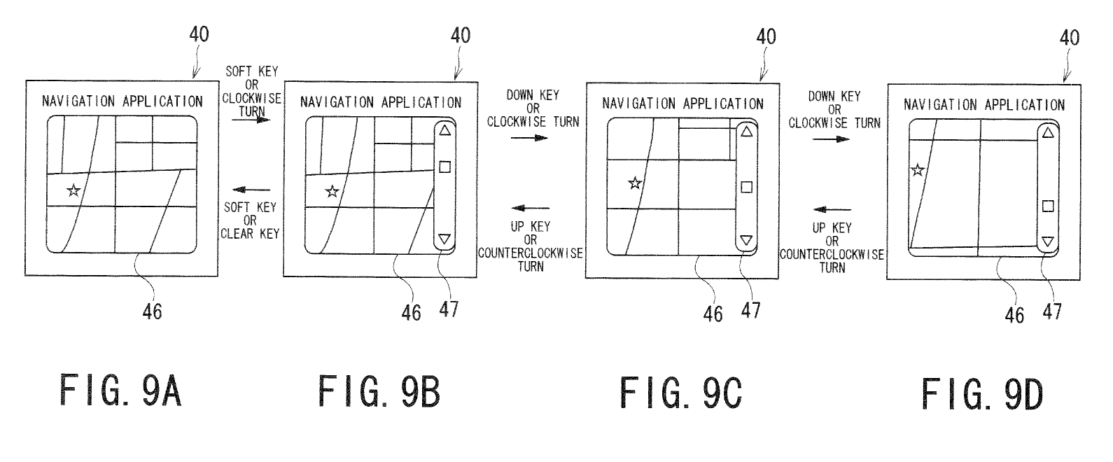

FIGS. 9A to 9D show the transitional state of the screen resulting from operating the turn key 15a when a navigation application screen 46 is displayed on the screen 40 of the display 13 in the state where the mobile phone 1 executes the navigation application program. Referring to FIG. 9A, when the default screen 46 for the navigation application is displayed, the key code in the default mode of the navigation application is set in the clockwise turn memory 33 and the counterclockwise turn memory 34.

When the soft key is depressed or the turn key 15a is turned clockwise in the aforementioned state, a scale bar 47 is displayed on the navigation application default screen 46 as shown in FIG. 9B. When the scale bar 47 is displayed on the navigation application default screen 46, the key code in the scale mode of the navigation application is set in the clockwise turn memory 33 and the counterclockwise turn memory 34. The key code in the scale mode has the clockwise turn correlated with the downward portion (down key) of the turn key 15a, and the counterclockwise turn correlated with the upward portion (up key) of the turn key 15a, respectively.

Referring to FIG. 9B, in the case where the scale bar 47 is displayed on the navigation application default screen 46, when the downward portion (down key) of the turn key 15a is depressed, or the turn key 15a is turned clockwise, the map on the navigation application default screen 46 is enlarged as shown in FIG. 9C. When the soft key or the clear key is depressed, the scale bar 47 is not displayed as shown in FIG. 9A. At this time, the key code in the navigation application default mode is set in the clockwise turn memory 33 and the counterclockwise turn memory 34.

In the case where the scale bar 47 is displayed on the navigation application default screen 46 as shown in FIG. 9C, when the downward portion (down key) of the turn key 15a is depressed, or the turn key 15a is turned clockwise, the enlarged map is displayed on the navigation or application default screen 46 based on the key code in the scale mode of the navigation application as shown in FIG. 9D. When the upward portion (up key) of the turn key 15a is depressed, or the turn key 15a is turned counterclockwise, the reduced map is displayed on the navigation application default screen 46 based on the key code in the scale mode of the navigation application as shown in FIG. 9B.

Referring to FIG. 9D, in the case where the scale bar 47 is displayed on the navigation application default screen 46, when the upward portion (up key) of the turn key 15a is depressed, or the turn key 15a is turned counterclockwise, the reduced map is displayed on the navigation application default screen 46 based on the key code in the scale mode of the navigation application as shown in FIG. 9C.

When the state of the application program executed with the most significance changes in the mobile phone 1, the key code may be switched in accordance with the state so as to allow the user to continue the operation with the turn key 15a without feeling discomfort even in the active application program.

The set unit 37 stores the information whether the turn key 15a is enabled or disabled, based on which the input through the turn key 15a is enabled or disabled. When the turn key 15a is disabled, the event conversion unit 32 does not inform the application program of the key event through the turning operation of the turn key 15a. When the turn key 15a is disabled, the power source for the device of the turn key 15a may be turned OFF.

In the case where the event conversion unit 32 converts the turning operation of the turn key 15a into the operation in the up-and-down direction, the relationship between up and down in the vertical operation will be inverted depending on whether the user turns the turn key 15a with the right hand or the left hand. The set unit 37 preliminarily stores the information whether the user is right-handed or left-handed. The event conversion unit 32 performs the conversion based on the information whether the user is right-handed or left-handed by switching between the key codes for clockwise turn and counterclockwise turn.

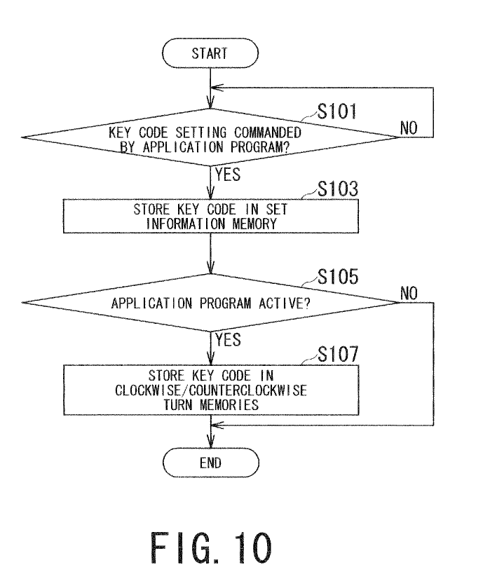

The routine performed by the new extension unit 20b and application control unit 36 for setting the key code upon execution of the application program by the main controller 20 will be described referring to the flowchart shown in FIG. 10. The term “step” in the flowchart will be omitted hereinafter, for example, “step S101” will be referred to as “S101”.

Upon activation of the application program by the main controller 20, the application program commands to set the key code of the predetermined input device (for example, the turn key 15a). The new extension unit 20b determines whether or not the key code setting has been commanded (S101). If the key code setting has not been commanded (No in S101), the new extension unit 20b is kept stand-by.

If the key code setting has been commanded (Yes on S101), the new extension unit 20b obtains the key code of the turn key 15a from the application program activated in S101 so as to be stored in the set information memory 35 (S103). If the key code of the turn key 15 is not designated by the application program, no information is stored.

The application control unit 36 determines whether or not the application program activated in S101 is active (S105). If it is active (Yes in S105), the application control unit 36 obtains the key code of the turn key 15a from the application program, and stores the clockwise turn key code in the clockwise turn memory 33, and the counterclockwise turn key code in the counterclockwise turn memory 34, respectively (S107).

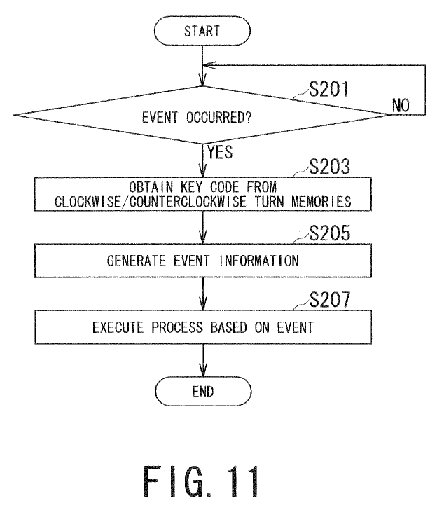

In the mobile phone 1 having the key codes set as described above, when the event of the predetermined input device (for example, the turn key 15a) occurs during execution of the application program by the main controller 20, the event conversion unit 32 performs the process corresponding to the event using the key codes set in S101 to S107. The procedure for performing the process in the mobile phone 1 will be described referring to the flowchart shown in FIG. 11. It is assumed that the key code of the predetermined input device (for example, turn key 15a) has been set in the clockwise turn memory 33 and the counterclockwise turn memory 34 through the process from S101 to S107.

When the event occurs through turning operation of the turn key 15a, the event control unit 31 transmits the electric signal to the event conversion unit 32. The event conversion unit 32 determines whether or not the event of the turn key 15a has occurred (S201). At this time, the event conversion unit 32 determines that the event has occurred based on reception of the electric signal indicating the event from the event control unit 31. If the event has not occurred (No in S201), the event conversion unit 32 is kept stand-by.

If the event occurs (Yes in S201), and the event in S201 is the clockwise turning of the turn key 15a, the event conversion unit 32 obtains the clockwise turn key code from the clockwise turn memory 33. If the event in S201 is the counterclockwise turning of the turn key 15a, the event conversion unit 32 obtains the counterclockwise turn key code from the counterclockwise memory 34 (S203).

Based on the key code obtained in step S203, the event conversion unit 32 generates event information with respect to the event which occurs in step S201 (S205). If the event which occurs in step S201 is the clockwise turning of the turn key 15a, the event conversion unit 32 generates the event information based on the clockwise turn key code. If the event which occurs in step S201 is the counterclockwise turning of the turn key 15a, the event conversion unit 32 generates the event information based on the counterclockwise turn key code. At this time, the event conversion unit 32 obtains the information indicating whether the turn key 15a is enabled or disabled from the set unit 37. If the turn key 15a is disabled, the event information is not generated. The event conversion unit 32 obtains the information indicating whether the user is right-handed or left-handed from the set unit 37, and converts the event information as needed.

The main controller 20 obtains the event information generated by the event conversion unit 32, and executes the process corresponding to the event information based on the active application program.

The mobile phone 1 stores the key code designated by the active application program as needed. In response to the event resulting from the turning operation of the turn key 15a, the event conversion unit 32 executes the event process based on the key code designated by the active application.

In case of the event resulting from the turning operation of the turn key 15a, when the key code is not designated by the active application program, the mobile phone 1 executes the event process based on the preliminarily set default key code.

The first embodiment allows the user to perform the appropriate operation in response to the event of the input device irrespective of the active application program.

When the new event undefined by the platform of the application program occurs in the mobile phone 1, the application program corresponding to the input device is capable of receiving such event as the arbitrary one designated by the application program. The application program which does not correspond to the input device is capable of receiving the new event as the standard key event. Both the application program which corresponds to the input device and the one which does not correspond to the input device may be executed for the control of the input device with the least, man-hour.

### Second Embodiment

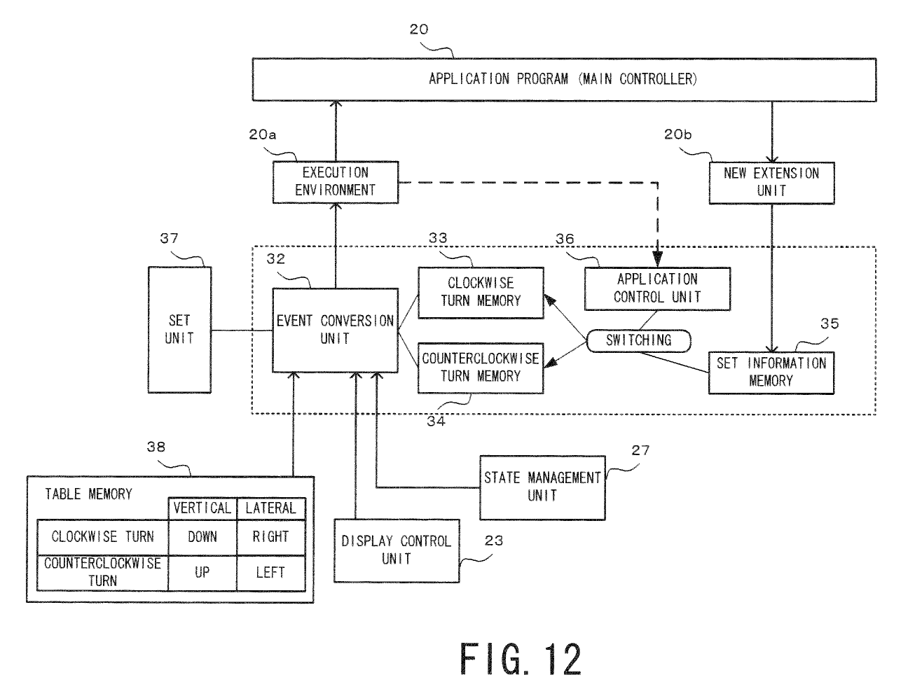

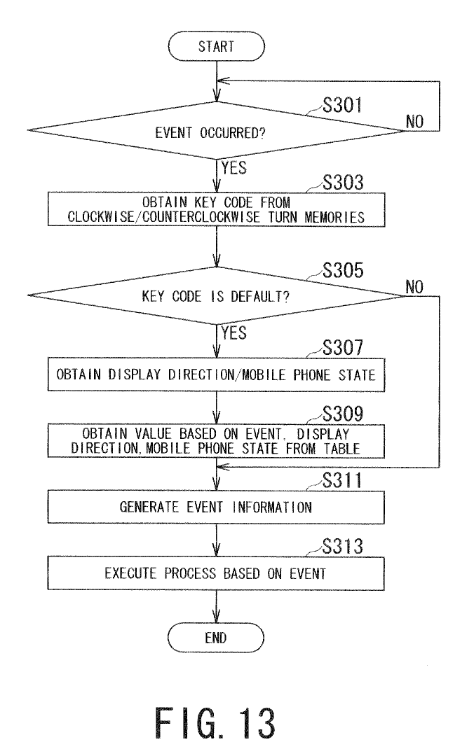

A mobile terminal and a key code setting method of the mobile terminal according to a second embodiment of the present invention will be described referring to FIGS. 12 and 13. The mobile terminal according to the second embodiment will be described taking the clamshell type mobile phone 1 as the example likewise the first embodiment. The same components as those of the first embodiment will be designated with the same reference numerals, and explanations thereof, thus will be omitted.

Referring to FIGS. 1 and 2, the mobile phone 1 according to the second embodiment has the same structure as that of the mobile phone 1 according to the first embodiment. Likewise the mobile phone 1 of the first embodiment, the mobile phone 1 according to the second embodiment includes the main controller 20, the power source circuit 21, the operation input control unit 22, the display control unit 23, the audio control unit 24, the communication control unit 25, the memory 26, and the state management unit 27 which are connected and communicated one another via bus lines.

The mobile phone 1 of the second embodiment is structured to control the event of the turn key 15a in accordance with a display direction of the display 13 whether the direction of the display 13 is vertical or lateral, or the holding state of the mobile phone 1 whether the mobile phone 1 is held in the vertical direction or the lateral direction.

For example, assuming that the default event of the turn key 15a is set as the key event in the up-and-down direction, when the display 13 performs the lateral display, the up-and-down direction viewed from the user may be seen in the left-to-right direction on the software. Then the mobile phone 1 is structured to convert the default event into the event in the left-to-right direction when the display 13 performs the lateral display.

FIG. 12 shows a structure of the software module which allows the operation input control unit 22 of the mobile phone 1 to execute the input control with the turn key 15a.

Upon reception of the electric signal indicating the event of the turn key 15a from the event control unit 31, the event conversion unit 32 obtains the display direction of the display 13 from the display control unit 23 or obtains the holding state of the mobile phone 1 from the state management unit 27 when the clockwise turn key code stored in the clockwise turn memory 33 and the counterclockwise turn key code stored in the counterclockwise turn memory 34 are default values. In consideration with the obtained information data, the event information based on the application program is generated so as to be transmitted to the main controller 20 which executes the application program. When the active application program does not designate the key code, each of the clockwise turn memory 33 and the counterclockwise turn memory 34 stores “0” as the default value.

The table memory 38 stores the key code of the turn key 15a based on the display direction of the display 13 and the holding state of the mobile phone 1. The key code stored in the table memory 38 is used when the key codes stored in the clockwise turn memory 33 and the counterclockwise turn memory 34 are default values.

Referring to FIG. 12, in the case where the application program executed by the main controller 20 does not have the set information with respect to the clockwise turn key code and the counterclockwise turn key code, and the display direction of the display 13 is vertical, the clockwise turning event of the turn key 15a is converted into the upward event, and the counterclockwise turning event of the turn key 15a is converted into the downward event, respectively. In the case where the display direction of the display 13 is lateral, the clockwise turning event of the turn key 15a is converted into the counterclockwise turning event, and the counterclockwise turning event of the turn key 15a as converted into the clockwise turning event, respectively.

The application program executed by the main controller 20 commands the display control unit 23 to perform the lateral display for realizing the lateral display on the display 13. The software at the application program changes nothing with respect to the event of the turn key 15a such that the event is converted based on the table stored in the table memory 38 when the event of the turn key 15a occurs.

When the event of the predetermined input device (for example, turn key 15a) occurs during execution of the application program by the main controller 20, the event conversion unit 32 of the mobile phone 1 executes the process corresponding to the event using the key code set in S101 to S107, or the key code stored in the table memory 38. The procedure of the aforementioned process performed by the mobile phone 1 will be described referring to FIG. 13.

When the event such as turning of the turn key 15a occurs, the event control unit 31 transmits the electric signal to the event conversion unit 32. The event conversion unit 32 determines whether or not the event of the turn key 15a has occurred (S301). The event conversion unit 32 determines that the event has occurred based on the electric signal indicating the event received from the event control unit 31. If the event has not occurred (No in S301), the event conversion unit 32 is kept stand-by.

If the event has occurred (Yes in S301), and the event determined as having occurred in S201 corresponds to the clockwise turning of the turn key 15a, the event conversion unit 32 obtains the clockwise turn key code from the clockwise turn memory 33. Meanwhile, if the event determined as having occurred in S201 corresponds to the counterclockwise turning of the turn key 15a, the event conversion unit 32 obtains the counterclockwise turn key code from the counterclockwise turn memory 34 (S303).

The event conversion unit 32 determines whether or not the key code obtained in S303 is the default value (S305). Based on the key code value of “0”, the event conversion unit 32 determines the key code as the default value.

If the key code obtained in S303 is the default value (Yes in S305), the event conversion unit 32 obtains the information indicating the display direction on the display 13 from the display control unit 23, or the information indicating the state of the mobile phone 1 from the state management unit 27 (S307). Based on the event occurred in step S301, and the information obtained in step S307, the event control unit 32 obtains the key code from the table memory 38 (S309).

Referring to FIG. 9, in the case where the clockwise turning event of the turn key 15a occurs in step S301, and the information indicating the vertical display direction of the display 13 is obtained in step S305, the upward key code is obtained from the table of the table memory 38.

The event conversion unit 32 generates the event information with respect to the event which has occurred in S301 (S311). In the case where the event which has occurred in step S301 is the clockwise turning of the turn key 15a, and the key code obtained in S307 is not the default value, the event conversion unit 32 generates the event information based on the clockwise turn key code. In the case where the event which has occurred in S301 is the counterclockwise turning of the turn key 15a, and the key code obtained in step S307 is not the default value, the event conversion unit 32 generates the event information based on the counterclockwise turn key code.

If the key code obtained in S307 is the default value, the event conversion unit 32 generates the event information based on the key code obtained in S309. The main controller 20 obtains the event information generated by the event conversion unit 32 in S311, and executes the process corresponding to the event information based on the active application program.

When the turn key 15a is turned to cause the event while using the mobile phone 1, the event conversion unit 32 obtains the key code designated by the active application program based on the event. If the obtained key code is the default value, the key code is changed in accordance with the display direction on the display 13 and the holding state of the mobile phone 1 such than the event process is executed based on the key code.

The second embodiment allows the user to perform appropriate operation in response to the event of the input device irrespective of the active application program.

If the input device of the mobile phone 1 is located at the position depending on the display and the flip position, the input device control may be realized without correcting the code even if the application program incompatible to the input device is executed.

The present invention has been described with respect to the mobile phone 1. It is to be understood that the present invention may be formed as an arbitrary mobile terminal such as the PHS, PDA, portable game player, portable music player, and a notebook PC so long as it is capable of accommodating new input devices.

What is claimed is:

1. A mobile terminal provided with a predetermined input device, comprising:
a first set unit configured to set a key code for the input device, which is designated by an active program;
a first memory unit configured to store a predetermined key code of the input device; and
an execution unit configured to execute a process based on the key code of the input device that is set by the first set unit when an event of the input device occurs, and executes a process based on the key code stored in the first memory unit when the key code of the input device is not set by the first set unit.

2. The mobile terminal according to claim 1, comprising a second memory unit configured to store the key code of the input device designated by each of plural programs in active states,
wherein the first set unit obtains the key code of the input device from the second memory unit based on the program executed with the most significance, and sets the obtained key code.

3. The mobile terminal according to claim 1, comprising a second set unit configured to set whether or not the input device is disabled,
wherein the execution unit is structured not to execute the process based on the key code when the input device is disabled by the second set unit.

4. The mobile terminal according to claim 1, wherein:
the input device is a turn key which is turned to input data;
the first set unit sets a key code corresponding to a clockwise turn event of the input device, and a key code corresponding to a counterclockwise turn event of the input device; and
the first memory unit stores the key code corresponding to the clockwise turn event of the input device, and the key code corresponding to the counterclockwise turn event of the input device.

5. The mobile terminal according to claim 4, comprising a third set unit configured to set whether or not a user is left-handed,
wherein the execution unit switches between the key code corresponding to the clockwise turn event of the input device and the key code corresponding to the counterclockwise turn event of the input device for executing the process when the third set unit sets that the user is left-handed.

6. The mobile terminal according to claim 1, comprising:
a display unit for displaying a screen; and
a third memory unit configured to store the key code of the input device correlated with a display direction of the screen displayed on the display unit,
wherein the execution unit obtains the key code of the input device from the third memory unit based on the display direction of the screen on the display unit when the key code of the input device is not set by the first set unit in case of the event of the input device, and executes the process based on the key code.

7. The mobile terminal according to claim 1, comprising a fourth memory unit configured to store the key code of the input device correlated with a direction of the mobile terminal held by the user,
wherein the execution unit obtains the key code of the input device from the fourth memory unit based on the direction of the mobile terminal held by the user when the key code of the input device is not set by the first set unit in case of the event of the input device, and executes the process based on the key code.

8. The mobile terminal according to claim 1, wherein the execution unit makes the input device be disabled, while an event set the same key code as the the input device's occurs.

9. The mobile terminal according to claim 2, wherein the second memory unit stores, when a program is initiated, a key code designated by the program and deletes, when the program is terminated, the key code.

10. The mobile terminal according to claim 4, wherein the execution unit assumes an event of the input device occurs when the input device is turned predetermined degrees.

11. A key code setting method of a mobile terminal comprising:
a first setting step of setting a key code for the input device, which is designated by an active program; and
a executing step of executing a process based on the key code of the input device that is set at the first setting step when an event of the input device occurs, and executes a process based on a predetermined key code when the key code of the input device is not set at the first setting step.

12. The key code setting method of the mobile terminal according to claim 11, wherein the key code of the input device is set based on the program executed with the most significance at the first setting step.

13. The key code setting method of the mobile terminal according to claim 11, wherein the process based on the key code is not executed when the input devise is disabled at the executing step.

14. The key code setting method of the mobile terminal according to claim 11, wherein when the input device is a turn key which is turned to input data, a key code corresponding to a clockwise turn event of the input device, and a key code corresponding to a counterclockwise turn event of the input device are set at the first setting step.

15. The key code setting method of the mobile terminal according to claim 14, comprising a third setting step for setting whether or not a user is left-handed,
wherein when that the user is left-handed is set at the third setting step, the key code corresponding to the clockwise turn event of the input device and the key code corresponding to the counterclockwise turn event of the input device are switched between for executing the process at the executing step.

16. The key code setting method of the mobile terminal according to claim 11, wherein when the key code of the input device is not set at the first setting step in case of the event of the input device, the key code of the input device is obtained based on the display direction of the screen on a display unit and the process based on the key code is executed in case of the event of the input device at the executing step.

17. The key code setting method of the mobile terminal according to claim 11, wherein when the key code of the input device is not set at the first setting step in case of the event of the input device, the key code of the input device is obtained based on the direction of the mobile terminal held by the user and the process based on the key code is executed in case of the event of the input device at the executing step.

18. The key code setting method of the mobile terminal according to claim 11, wherein the input device is disabled while an event set the same key code as the input device's occurs at the executing step.

19. The key code setting method of the mobile terminal according to claim 12, comprising:
a storing step for storing, when a program is initiated, a key code designated by the program is stored; and
a deleting step for deleting, when the program is terminated, the key code.

20. The key code setting method of the mobile terminal according to claim 14, wherein it is assumes an event of the input device occurs when the input device is turned predetermined degrees at the executing step.
